(19) United States
(12) Patent Application Publication
(10) Pub. No.: US 2003/0156024 A1
(43) Pub. Date: Aug. 21, 2003

(54) Saw device with integral patch antenna

(76) Inventor: John Beckley, Bicester (GB)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/362,888

(22) PCT Filed: Aug. 8, 2001
(86) PCT No.: PCT/GB01/03572

(30) Foreign Application Priority Data
Aug. 8, 2000 (GB) 0019497.7

(51) Int. Cl. B60C 23/00

(52) U.S. Cl. 340/447; 310/313 R

(57) ABSTRACT

A sensor assembly, particularly suitable for use on a vehicle wheel to sense, e.g. the pressure within a vehicle tyre, comprises a patch antenna (3) and a SAW device (2). The patch antenna comprises conductive sheets (4, 5) of substantially equal surface area separated by a dielectric spacer (6). The SAW device may be located between the plates (3, 5) within the thickness of the dielectric material. The patch antenna may he secured to the wheel rim of a vehicle wheel so that one of the antenna plates is capacitively coupled to the metal of the wheel thereby forming an extended ground-plane. Such an arragement produces a low profile sensor/antenna combination which has a maxiumum gain in the radial direction of the wheel.

This invention relates to a SAW device having an integral patch antenna.

SAW devices have been proposed for a number of applications in which the SAW device is interrogated by means of circuitry physically remote from the SAW device and coupled thereto by an RF link. Such arrangements are described, for example, in United Kingdom patent application GB 2328086A (where the SAW device is used to measure the torsional deflection of a shaft) and in United Kingdom patent application 9917579.6 (wherein the SAW device is used to measure tyre pressure). Whilst a large range of physical parameters may be measured by means of suitably designed transducers incorporating SAW devices, the application of such devices has heretofore been limited by the requirements of the antenna system necessary to connect the SAW device to its associated excitation and analysis circuitry.

The problems outlined above are particularly acute where the SAW device is required to operate within the tyre of a motor vehicle. The use of SAW devices in such circumstances has the well recognised advantage that, in contrast with other tyre pressure monitoring systems, SAW devices require no batteries. However, a SAW device does require an antenna to provide communication to external circuitry. Heretofore monopole antennas and helical antennas have been proposed. However both of these have a problem in that they work best when placed at right angles to a ground plane. The wheel rim being a large mass of metal and will act as a ground plane. The problem here is that to allow for easy installation of the tyre over the rim these types of antenna need either to be made very short or bent so that then run parallel to the wheel rim In either case the performance and efficiency of the antenna will be adversely affected.

In accordance with one aspect of the present invention a SAW device and a patch antenna are formed as an integral sensor for application to a supporting surface.

The use of a patch antenna provides a number of advantages as compared with conventional monopole and helical antennae. A patch antenna can be formed as a relatively thin robust structure which can readily be applied to a suitable surface, for example to a wheel rim or to the surface of a tyre or incorporated in a run-flat tyre system. As well as overcoming many of the physical installation problems associated with the prior art outlined above the radiation pattern of a patch antenna is such that the majority of the radiation is in the direction normal to the plane of the patch. This characteristic can be utilised so as to concentrate the gain of the antenna in the direction of an associated antenna of the interrogation system.

Patch antenna are known from the prior art, but such antenna are usually fed by transmission lines which may be a coax feed from the reverse of the board or via a microstrip feed made on the same substrate as the patch. Either way normally the circuitry to which the antenna is providing a link is separate from the antenna itself. However, as a SAW sensor is relatively small it can be integrated directly into the patch itself Also normally the ground plane of the antenna is noticeably larger than the patch and the feed connects directly between the patch and the ground plane. However in this application the dielectric material is preferably cut to the same size as the conducting patch on the upper most surface and a conducting surface of the same size is placed on the reverse side, and the feed is connected between the two. As the area of the patch is relatively large, if it is to be mounted against a metal surface (e.g. wheel rim) there will be a large capacitive coupling between this bottom plate and the rim even if there is not a direct electrical connection. This is useful because many rims are painted to prevent corrosion and it would require an extra operation and a modification to the rim to make a connection here.

There has already been a lot of work carried out on patch antennas and hence there are many different standard formulas for calculating the required physical parameters knowing the desired frequency of operation. However as the patch antenna required for this application varies from the present standard and as such these formulas no longer hold true, although they can be used to give an approximation of the required dimensions. Probably the most important dimension is electric length of the patch as this sets its preferred operating frequency. The patch antenna works best as a half wavelength resonator and integer multiples there of. So an approximation of the required physical length can be given by:

$$L = \frac{{v}_{o}}{2 \cdot {f}_{r} \cdot \sqrt{eff}}$$

Where

| | |
|---|---|
| L | is the physical length in meters |
| Vo | is the speed of light in meters/seconds |
| Fr | is the required operating frequency in hertz |
| Eff | if the effective dielectric of the substrate |

The height of the substrate predominantly effects the bandwidth of the antenna whilst the width and the distance of the feed point along the length predominantly effects the input impedance of antenna which can be chosen to directly match to that of the SAW sensor. This removes the need of any additional matching components.

The invention will be better understood from the following description of a preferred embodiment thereof, given by way of example only, reference being had to the accompanying drawings wherein:

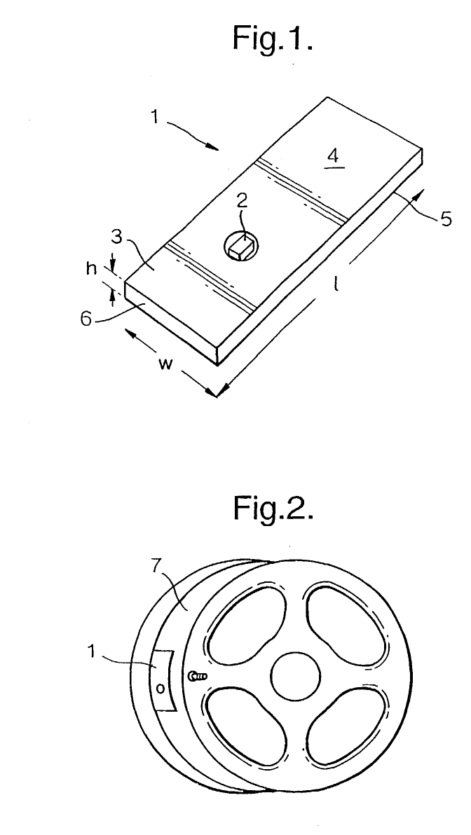

FIG. 1 illustrates schematically and in perspective view a preferred embodiment of the present invention; and

FIG. 2 illustrates the embodiment of FIG. 1 in use on the rim of a wheel of a motor vehicle.

Referring firstly to FIG. 1 illustrated device 1 comprises a passive sensor 2, for example a SAW pressure transducer, and a patch antenna 3 comprising an upper conductive plate 4, a lower conductive plate 5 and a dielectric material spacer 6. The passive sensor 2 is integrated with the patch antenna by being mounted on the surface thereof or physically mounted within the structure of the antenna between the conductive plates 4 and 5.

The size of the various components of the assembly is calculated in accordance with the instructions given above.

FIG. 2 illustrates a typical use of the assembly 1 of FIG. 1. The assembly is secured by suitable means, for example adhesive, to the rim 7 of a motor vehicle wheel to act as a pressure sensor. Because of the high level of capacative coupling between the base plate 5 and the wheel rim electrical contact between the base plate 5 and the wheel rim is not necessary and accordingly the device may be applied by means of adhesive over an existing paint coating. The transmission characteristics of the patch aerial ensure that the maximum gain of the aerial extends radially of the wheel with the result that a complementary aerial placed within the wheel arch of the vehicle may couple with the aerial on the wheel rim with high efficiency.

1. A sensor assembly for providing an indication of a condition, the sensor assembly comprising: a SAW device which can be interrogated by radio frequency (RF) signals to provide an indication of the value of the condition; and an antenna connected to the SAW device to receive RF signals from a remote interrogation device and pass the received signals to the SAW device, and to receive RF signals from the SAW device and transmit them to the remote interrogation device, wherein the antenna is a patch antenna and the antenna and SAW device are pre-formed as a unit which can be placed at a location where the condition is to be sensed for remote interrogation by the interrogation device.

2. A sensor assembly according to claim 1 wherein the patch antenna comprises two sheets of metal separated by a sheet of dielectric material.

3. A sensor assembly according to claim 2 wherein the two sheets of metal are of the same area as each other.

4. A sensor assembly according to claim 3 wherein the sheet of dielectric material is of the same area as the metal sheets.

5. A sensor assembly according to any preceding claim wherein the SAW device is mounted on the surface of the patch antenna.

6. A sensor assembly according to any of claims 2 to 4 wherein the SAW device is mounted in the assembly between the sheets of metal.

7. A sensor assembly according to any preceding claim wherein the length (L) of the antenna is approximately:
$$L = \frac{{v}_{o}}{2 \cdot {f}_{r} \cdot \sqrt{eff}}$$
Where

| | |
|---|---|
| L | is the physical length in meters |
| υₒ | is the speed of light in meters/seconds |
| fr | is the operating frequency in hertz of the SAW device |
| eff | if the effective dielectric of the substrate |

8. A method of sensing a condition of a vehicle wheel/tyre assembly, the method comprising: providing a sensor assembly according to any preceding claim which is sensitive to the condition to be sensed; securing the sensor assembly to the wheel with one sheet of the patch antenna coupled to the metal of the wheel; and interrogating the sensor assembly by means of an interrogation device mounted adjacent the wheel/tyre assembly.

9. A method according to claim 8 wherein the sensor assembly is adhesively secured to the wheel rim and the patch antenna is capacitively coupled to the wheel.

10. A method according to claim 8 or claim 9 wherein the sensor assembly is located such that the gain of the patch antenna is at a maximum in the radial direction of the wheel/tyre assembly.
